(19) United States
(12) Patent Application Publication
(10) Pub. No.: US 2010/0167036 A1
(43) Pub. Date: Jul. 1, 2010

(54) SOLID POLYMERIC MATERIALS FOR DETECTION, TRANSFER, AMPLIFICATION AND MEMORY OF CHIRALITY OF OPTICALLY ACTIVE COMPOUNDS

(75) Inventors: Annamaria Buono, Legnagio Mi (IT); Gaetano Guerra, Salerno Sa (IT); Paola Rizzo, Napoli Na (IT)

Correspondence Address: NIXON & VANDERHYE, PC, 901 NORTH GLEBE ROAD, 11TH FLOOR, ARLINGTON, VA, 22203, US

(73) Assignee: Universita Degli Studi Di, Fisciano SA (IT)

(21) Appl. No.: 12/293,710

(22) PCT Filed: Mar. 6, 2007
(86) PCT No.: PCT/IB07/50736

§ 371 Date: Oct. 10, 2008

(30) Foreign Application Priority Data
Mar. 21, 2006 (IT) SA2006A000008

(51) Int. Cl. B32B 27/32; C08J 9/06; C08F 12/08

(52) U.S. Cl. 428/220; 521/146; 521/97; 521/87; 521/94

(57) ABSTRACT

Solid polymeric materials for detection, transfer, amplification and memory of chirality of optically active compounds are described. These materials not only are able to absorb also traces of volatile organic compounds (both chiral and achiral) prevailingly as guest of a nanoporous crystalline phase, but for the case of chiral guests are also able to transfer and amplify their chirality, producing intense phenomena of induced circular dichroism (ICD). This induced dichroism remains stable also after chiral guest removal, as well as after temperature increases at least up to 250° C. The solid polymeric materials of the present invention can find applications in sensorics of optically active molecules as well as in systems for storage of data.

The present invention relates to solid polymeric materials for detection, transfer, amplification and memory of chirality of optically active compounds. The invention is located in the technical-scientific fields of industrial chemistry and engineering, and, more specifically in the area of the molecular sensorics and of data storage.

### STATE OF THE ART

Chirality sensors are generally based on chiral host molecules interacting with chiral guest molecules. In particular, optically active cyclic compounds like cyclodextrins, cyclophanes, crown-ethers and optically active polymers are among the most extensively studied host molecules. For instance, two recent patents based on chiral polymers can be cited: US2002156217, Y. Eiji e M. Katsuhiro or US2004041133, F. Michiya, K. Masashi e O. Akihiro. However, these receptors are often unsuitable as chirality sensors based on measurements of circular dichroism (CD), due to their high specificity as well as due to their intrinsic circular dichroism.

Recently, chirality sensors based on achiral host receptors have been also proposed. In the case of these sensors, non-covalent interactions with chiral guest molecules generate an induced circular dichroism (ICD) in the receptor absorbance region. Particularly suitable are macromolecular receptors, which can amplify the chirality of optically active low-molecular-mass compounds, when co-operative interactions produce a prevalence of polymer helices with right or left handedness. In this respect, it is cited for instance the patent JP2001316476, N. Hiroshi and F. Michiya.

These chirality transfer and amplification phenomena have been generally observed in solution. As for achiral solid polymeric materials, in the literature only a study describing chirality transfer of an optically active rigid polysilane to an optically inactive polysilane has been reported (A. Saxena, G. Guo, M. Fujiki, Y. Yang, A. Ohira, K. Okoshi, M. Naito Macromolecules, 2004, 37, 3081-83).

In general, solid polymeric materials show several advantages as sensing elements for detection of chemical substances: they present relatively low cost and simple processing techniques (not involving high purity environments or high temperatures) and can be deposited on different kinds of substrates. However, solid polymeric materials generally show a low selectivity in the molecular absorption, since it generally occurs in amorphous phases.

In recent years (It.Pat. IT1228915, Application RM94A00030) materials based on syndiotactic polystyrene, presenting the δ crystalline nanoporous phase, being able to include in said crystalline phase low-molecular-mass guest molecules, have been discovered. Moreover, it has been disclosed that these materials can be used as sensing elements for detection, in water and air, of volatile, mainly hydrocarbon, organic compounds (It.Pat. Appl.N.SA00A23; Eur.Pat. Appl.01830779.3). However, these sensing elements being achiral, although they are able to efficiently absorb also chiral guest molecules, they are in general not able to detect their chirality.

It has been now surprisingly found that solid polymeric materials based on syndiotactic polystyrene, presenting the δ nanoporous crystalline phase, where said crystalline phase is organized in elongated morphologies with shape-ratio higher than 5 and minor size in the range 10-0.01 μm, are useful for detection, transfer, amplification and memory of chirality of optically active compounds. These materials can be obtained by crystallization processes from flowing polymeric solutions, such as, for instance, spin-coating processes.

Is therefore an object of the present invention a process for the manufacture of solid polymeric materials based on syndiotactic polystyrene in its δ nanoporous crystalline form or on styrene copolymers with olefins CH₂═CH—R, wherein R is an alkyl-aryl or a substituted aryl radical with 6-20 carbon atoms, or with other co-polymerizable ethylenically unsaturated monomers, said copolymers being syndiotactic and crystallisable in the δ nanoporous crystalline form, wherein said crystalline form is organized in elongated morphologies with shape-ratio higher than 5 and minor size in the range 10-0.01 μm, characterized by the following steps: a) dissolution of syndiotactic polystyrene or of syndiotactic styrene copolymers with olefins CH₂═CH—R, wherein R is an alkyl-aryl or a substituted aryl radical with 6-20 carbon atoms, or with other co-polymerizable ethylenically unsaturared monomers, in a solvent chosen from the class formed by halogenated solvents, aromatic solvents, cyclic aliphatic solvents, sulphur containing solvents, up to the achievement of a solution of said polystyrene or said copolymers.

b) flow-crystallization of said solution obtained by step a) on a support up to the achievement of a semicrystalline sample and

c) treatment of said semicrystalline sample with volatile guests of said syndiotactic polystyrene and, or of said syndiotactic copolymers, whereby said polystyrene and, or copolymers, in said sample are obtained in the δ nanoporous crystalline form.

The present description contains three drawings showing:

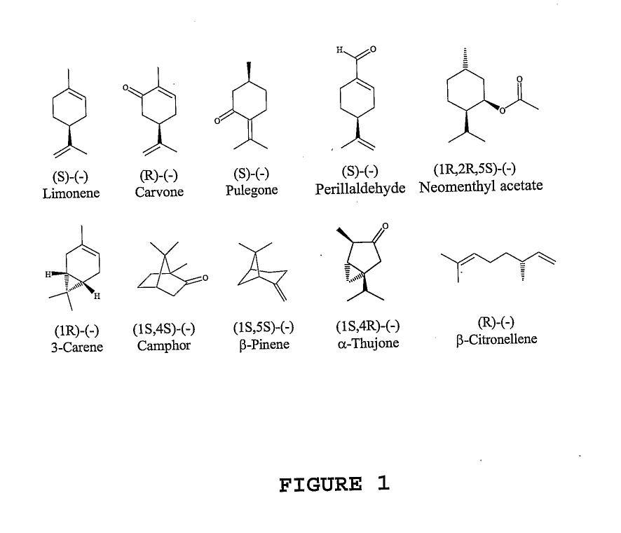

FIG. 1 the structures of some optically active molecules which can be detected with the materials object of the invention;

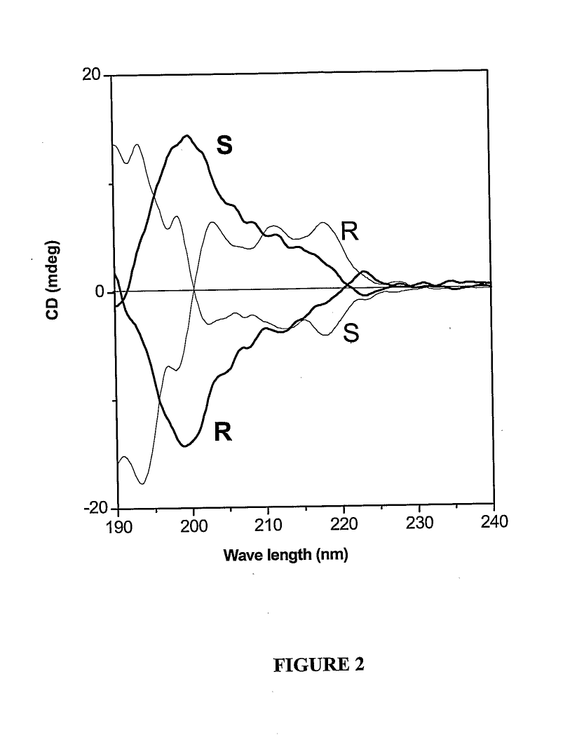

FIG. 2 circular dichroism spectra in the 190-240 nm wavenumber range of a polystyrene film, about 0.2 μm thick, when exposed to R-limonene and S-limonene: (thin lines) atactic polystyrene exposed for three days; (thick lines) syndiotactic polystyrene exposed for three minutes.

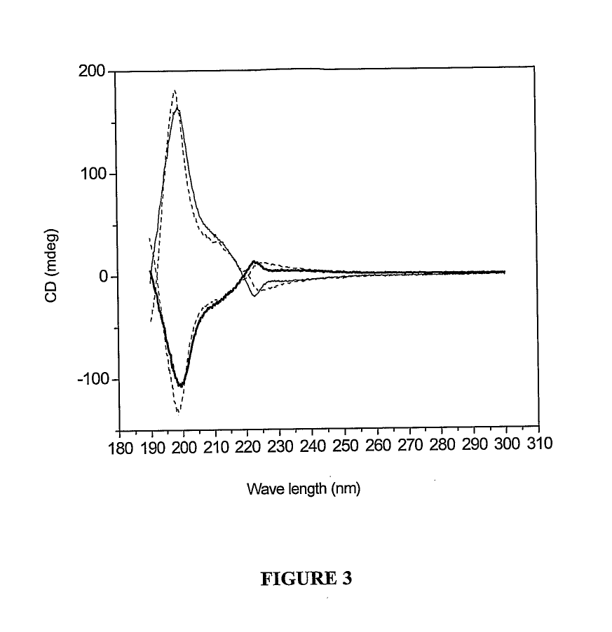

FIG. 3 circular dichroism spectra in the 180-300 nm wavenumber range of a syndiotactic polystyrene film about 0.2 μm thick, when exposed to R-carvone and S-carvone (continuous lines) and after treatment at 220° C. for 5 minutes (dashed lines).

Under syndiotactic polystyrene (sPS), it is meant a polymer where the syndiotactic structure is present for at least long traits of the polymer chain so to allow the polymer crystallization into the δ nanoporous crystalline form. This polymer can be obtained following the method described in the European patent application N^{o} 0271875-Himont Italia. According to the present invention under syndiotactic polystyrene are also meant styrene copolymers, having a prevailing syndiotactic microstructure and that can be crystallised in the nanoporous δ crystalline form, with CH₂═CH—R olefins, wherein R is an alkyl-aryl or a substituted aryl radical with 6-20 carbon atoms, or with other ethylenically unsaturated monomers, which can be copolymerized.

The δ nanoporous crystalline form of s-PS according to the description of Italian patent IT1228915 (application RM94A00030) and in Italian patent appln. No. SA2003A14 (PCT appln. WO2005012401) is characterized by a X-ray diffraction pattern presenting reflections of greater intensity at 2θ (CuKα)≈8.4°, 10.6°, 13.3°, 16.8°, 20.7°, 23.5°, and by an intensity ratio between the intensities of the two peaks Ī(8.4°/I(10.6°, larger than 5. Semicrystalline films based on syndiotactic polystyrene, in the δ nanoporous crystalline form, can be obtained starting from films presenting a molecular-complex crystalline form (clathrate or intercalate, i.e. enclosing solvent guest molecules in the crystalline phase), through one of the procedures described in previous patents. For instance, according to the description of the Italian patent IT1226915, materials in the δ nanoporous form can be obtained through, washing with suitable solvents, or in gas flow, of materials presenting molecular-complex crystalline forms, solvents that can be used for said washing are, for instance, acetone and methyl-ethyl-ketone. Moreover, as described in Italian Patent n. IT1306004, extraction processes with carbon dioxide, liquid or in supercritical conditions are particularly efficient.

Depending on the chosen crystallization process, different morphologies of said molecular-complex crystalline phases, as well as of the corresponding nanoporous phases, can be obtained. The polymeric materials object of the present invention not only have to present the δ nanoporous crystalline phase, but said crystalline phase has to be organized in elongated morphologies, with a shape-ratio higher than 5 and minor size in the range 10-0.01 μm. Said morphologies can be studied by several techniques of microscopy, the Atomic Force Microscopy (AFM) being the most effective. Said morphologies can be better pointed out by sample treatments with oxidizing agents, such as for instance acid solutions of potassium permanganate.

Nanoporous crystalline phases of sPS with elongated morphologies, which can be used for chirality sensors, can be obtained from molecular-complex phases crystallized by procedures that utilize flowing polymeric solutions, such as for instance spin-coating.

For spin-coating processes (as disclosed in step b) the spin-rate has to be higher than 100 rounds/minute and preferably higher than 300 rounds/minute.

In the process according to the invention, suitable solvents are halogenated solvents, such as chloroform, methylene chloride, carbon tetrachloride, dichloroethane, trichloroethylene, tetrachloroethylene, dibromoethane, methyliodide, aromatic solvents such as benzene and styrene, cyclic aliphatic solvents such as cyclohexane and tetrahydrofurane, sulphur containing solvents like carbon disulfide. Particularly suitable solvents are chloroform and tetrahydrofurane.

At the end of step b), the semicrystalline sample is advantageously obtained in shape of a film of a thickness lower than 100 μm, preferably lower than 1 μm. This makes the polymeric material, as obtained by the invention procedure, particularly suitable for the use as sensing element for molecular sensors.

Step c) of the process of the invention is required to obtain in the δ nanoporous crystalline phase the semicrystalline sample obtained by step b). This result can be reached by treating the semicrystalline sample with volatile guests of s-PS. A suitable procedure comprises a treatment with carbon dioxide in supercritical conditions, said supercritical conditions corresponding to temperatures in the range between room temperature and 100° C., preferably between 30 and 70° C., pressure in the range 60 and 800 bar, preferably between 60 and 150 bar, for a time preferably in the range between 1 and 60 minutes.

A second suitable procedure comprises the polymer treatment with solvents which are volatile guests of syndiotactic polystyrene, such as acetone or acetonitrile followed by a thermal treatment at temperatures lower than 70° C. for the complete removal of said solvents.

Further objects of the present invention are the polymeric materials obtainable according to the invention process, particularly in form of films with a thickness lower than 100 μm, preferably lower than 1 μm.

The materials obtainable according to the process of the invention can be used, and this is also object of the present invention, for detection, transfer, amplification and memory of chirality of optically active compounds.

The solid polymeric materials object of the present invention not only allow to absorb also traces of volatile compounds (both chiral and achiral) prevailingly as guests of the nanoporous crystalline phase, as it is well known from the prior art. But, in case of chiral guests, and this is also object of the present invention, said materials are also able to transfer and amplify the guest chirality, because non-covalent interactions between polystyrene helices and chiral guests can produce intense induced circular dichroism (ICD) in the polymer absorbance region. Said induced dichroism remains stable also after removal of the chiral guest, as well as after temperature increases up to below the polymer melting temperature.

As a consequence, the solid polymeric materials, object of the present invention, are able to maintain a memory of the chirality of the optically active molecules, which have been exposed to. This chirality memory can be deleted, restoring chiral sensibility, only by suitable treatments with solvents leading to polymer re-crystallization.

Nanoporous crystalline phases of sPS, which are obtained from molecular-complex phases crystallized from polymeric solutions through procedures with negligible flow, such as for instance casting or spray-coating or gelification of solutions followed by solvent removal (as, for instance, the processes leading to the aerogels described in the Italian patent n.SA2003A13, PCT Int. Appl. WO2005012402), cannot be used for chirality sensors.

Moreover, materials with nanoporous crystalline phases of sPS, which have been obtained from molecular-complex phases crystallized by exposure to solvents of solid samples, both amorphous and semicrystalline (for instance, with α or γ crystalline phases) cannot be used for chirality sensors.

Optically active compounds, whose chirality can be detected, transferred, amplified and memorized by the solid polymeric materials of the present invention, are those which are able to form molecular-complex crystalline phases, as a consequence of sorption in the δ phase of syndiotactic polystyrene.

The formation of molecular-complex crystalline phases can be, for instance, shown by X-ray diffraction patterns by considering the position of the crystalline reflection at lowest diffraction angle, to which generally (010) Miller indexes are attributed. In particular, the formation of molecular-complex crystalline phases is indicated by d₀₁₀ Bragg periodicity higher than 1.06 nm, corresponding to diffraction angles lower than 2θ≈8.3° for the case of CuKα radiation.

The formation of molecular-complex crystalline phases can be also shown by the presence of linear dichroism, for absorbance peaks in the infrared radiation region, of guest molecules in uniaxially stretched samples based on δ-form syndiotactic polystyrene, as described for instance by Albunia et al, Macromolecules, 2003, 36, 8695-8703.

It is to be noted that, for instance, the solid polymeric materials of the present invention is sensible to the chirality of optically active volatile compounds of natural origin such as limonene, carvone, pulegone, perillaldehyde, canphor, 3-carene, α-thujone, neomentyl-acetate, β-pinene and β-citronellene (whose molecular structures are reported in FIG. 1, for the enantiomers with negative optical-rotation power). Liquid and gaseous mixtures, from which these compounds can be detected, can be based on water and air.

The solid polymeric materials of the present invention, being generally made of non-chiral macromolecules, do not present any circular dichroism, i.e. no difference between absorbance of radiations with right or left circular polarization is present. As a consequence of exposure to optically active, molecules, which are suitable as guests of the δ nanoporous crystalline form, these polymeric materials develop induced circular dichroism phenomena, much more intense of the phenomena of intrinsic circular dichroism of said optically active molecules. Hence chirality amplification phenomena are observed.

It is worth noting that after guest molecules removal, both when spontaneous and when induced by a suitable extraction agent (for instance, carbon dioxide liquid or in supercritical conditions), the circular dichroism of the sensing element based on syndiotactic polystyrene remains essentially unchanged. This clearly confirms that the observed circular dichroism is induced, i.e. associated with a chiral organization of the achiral polymer. Moreover, the induced circular dichroism remains very intense also after thermal treatments leading to transitions between different crystalline phases. In particular, ICD remains intense not only after thermal treatments in the temperature range 100° C. e 170° C., leading to transitions toward the γ crystalline phase (also containing sPS chains in helical conformation, as the starting δ form) but also after thermal treatments in the temperature range 180° C. e 250° C., leading to the transition toward the α crystalline phase (containing sPS chains in zig-zag-planar conformation). The induced circular dichroism remains also essentially unaltered also after treatments with other chiral molecules, as well as after treatment with the same molecule to which the material has been originally exposed but having opposite optical activity.

Hence a phenomenon of memory of chirality is also observed.

This memory of chirality can be deleted, restoring chirality sensibility of the polymeric material, only by suitable treatments with solvents leading to polymer re-crystallization. Suitable solvents for these procedures are for instance chloroform and methylene chloride.

This memory of chirality can be also deleted by thermal treatments at temperatures higher than the polymer melting temperature (generally in the range 250-275° C.), however after this treatment the chirality sensibility of the polymeric material is usually lost.

The solid polymeric materials of the present invention can be used as sensing elements of sensors of optically active molecules, based on induced circular dichroism measurements. These measurements have to be carried out using electromagnetic radiations that are absorbed by syndiotactic polystyrene. When, in particular, ultraviolet (UV) radiation between 180 and 300 nm is used, the induced circular dichroism corresponds to the appearance of a principal band at nearly 200 nm and a secondary band of opposite sign at nearly 225 nm.

The sensing films based on sPS, with respect to other sensors of optically active molecules, show the advantage of a high sorption capacity of the analyte, also when it is present at low concentrations, which obviously increases the sensitivity of the sensor devices. The sensing films based on sPS moreover present the advantage of a higher molecular selectivity, with respect to other sensors based on polymeric films.

Hence, further objects of the present invention are sensors for detection, transfer, amplification and memory of chirality of optically active volatile compounds (mainly of chiral organic molecules), which contain as sensing elements polymeric materials according to the invention.

The high thermal stability of the chirality memory (generally up to 250° C.), associated with good optical and mechanical properties and excellent chemical stability of the used styrene polymers, make the materials, object of the present patent, suitable for the production of devices for memory of data.

Further object of the present invention are devices to memorize data, which are based on the materials of the present invention.

The following examples are intended to illustrate the invention without limiting the scope thereof.

### EXAMPLE 1

The used syndiotatic polystyrene was produced by “DOW Chemical” under the trademark Questra 101. The polymer pellets were dissolved in chloroform, thus preparing a 0.25 wt % solution of polymer. The solution was used in a spin-coating process, with a spin-rate of 1600 rounds/minute, on a quartz disc having a thickness of nearly 2 mm and a diameter of nearly 5 cm. The obtained film, having a thickness of nearly 0.2 μm, is in a clathrate form and includes chloroform in a quantity higher than 10 wt %. After treatment with carbon dioxide in supercritical conditions (T=45° C., P=200 bar, for 30 minutes) a film in the nanoporous δ form is obtained, as pointed out by infrared spectroscopy measurements. Atomic Force Microscopy (AFM images) of this film show the occurrence of elongated morphologies with shape-ratio higher than 100 and with minimum dimension in the range 1-0.1 μm.

This film does not present any circular dichroism phenomenon but when exposed to vapors of R-limonene and S-limonene, also for few seconds, presents the circular dichroism shown by the thick lines in FIG. 2. These CD spectra remain essentially unaltered after extraction of limonene by a process with carbon dioxide in supercritical conditions (T=45° C., P=200 bar, extraction time of 10 minutes) as well as after thermal treatments up to 250° C.

### COMPARATIVE EXAMPLE 1

The syndiotatic polystyrene produced by DOW Chemical under the Trademark Questra 101 has been used. The polystyrene pellets are dissolved in chloroform to prepare a solution with 0.25% by weight of polymer. The chloroform solution was used in a casting process on a quartz disc having a thickness of nearly 2 mm, followed by a slow solvent evaporation. The obtained film presents a thickness of nearly 0.2 μm, it is in the clathrate form and includes chloroform in an amount higher than 10 wt %. After a treatment with carbon dioxide in supercritical conditions (T=45° C., P=200 bar, time of treatment 30 minutes) the film is obtained in the nanoporous δ form, whose presence can be shown by infrared spectroscopy measurements.

This film does not present any circular dichroism phenomenon, also when exposed for several hours to R-limonene e S-limonene vapors.

### COMPARATIVE EXAMPLE 2

Atactic polystyrene is used in place of syndiotactic polystyrene used in the example 1. The pellet is dissolved with chloroform and a 0.25 wt % solution of polymer is prepared. Films with a thickness of nearly 0.2 μm are deposited by spin-coating on quartz crystals, as described in the example 1. These films exposed to vapors of R-limonene and S-limonene show significant dichroism phenomena only after long exposure times. CD spectra measured after 3 days of exposure of the amorphous films to R-limonene or S-limonene, reported in FIG. 2 (thin curves), are typical of limonene and, in fact, their dichroism vanishes after limonene extraction by carbon dioxide at supercritical conditions (T=45° C., P=200 bar, time of treatment 10 minutes) as well as after thermal treatments at 100° C.

### EXAMPLE 2

The same polymer and the same manufacture procedure of the sensing film of the example 1 are used. This film, exposed to vapors of R-carvone and S-carvone, for three minutes, shows the CD spectra reported as continuous lines in FIG. 3. These CD spectra remain essentially unaltered after carvone extraction by carbon dioxide (T=45° C., P=200 bar, overall time of treatment 10 minutes). The CD spectra of these films after thermal treatments for 5 minutes at 220° C., (dashed lines in FIG. 3) clearly show that the memory of chirality is maintained, also after high-temperature thermal treatments.

1-12. (canceled)

13. A process for the manufacture of solid polymeric materials based on syndiotactic polystyrene in its δ nanoporous crystalline form or on styrene copolymers with olefins CH₂═CH—R, wherein R is an alkyl-aryl or a substituted aryl radical with 6-20 carbon atoms, or with other co-polymerizable ethylenically unsaturated monomers, said copolymers being syndiotactic and crystallizable in δ nanoporous crystalline form, wherein said crystalline form is characterized by elongated morphologies with shape-ratio higher than 5 and minor size in the range 10-0.01 μm, said process comprising:
(a) dissolution of syndiotactic polystyrene, syndiotactic styrene copolymers, or both with olefins CH₂═CH—R, wherein R is an alkyl-aryl or a substituted aryl radical with 6-20 carbon atoms, or with other co-polymerizable ethylenically unsaturared monomers, in at least solvent selected from the group consisting of halogenated solvents, aromatic solvents, cyclic aliphatic solvents, and sulphur containing solvents, to obtain a solution of at least said polystyrene or said copolymers;
(b) flow-crystallization of said solution of said polystyrene, said copolymers, or both on a support to obtain a semicrystalline sample; and
(c) treatment of said semicrystalline sample with volatile guests of said polystyrene, said copolymers, or both, whereby said polystyrene, said copolymers, or both in said sample are obtained in δ nanoporous crystalline form.

14. The process according to claim 13, wherein said flow-crystallization is obtained by spin-coating with spin-rate >100 rounds/min, preferably >300 rounds/min.

15. The process according to claim 13, wherein said semicrystalline sample in step (b) is obtained as a film with thickness lower than 100 μm, preferably lower than 1 μm.

16. The process according to claim 13, wherein said solvent is selected from the group consisting of chloroform, methylene chloride, carbon tetrachloride, dichloroethane, trichloroethylene, tetrachloroethylene, dibromoethane, methyliodide, benzene, styrene, cyclohexane, tetrahydrofurane, and carbon disulfide.

17. The process according to claim 13, wherein said solvent is selected from the group consisting of chloroform and tetrahydrofurane.

18. The process according to claim 13, wherein said treatment of said semicrystalline sample by a volatile guest of said polystyrene, said copolymers, or both comprises a treatment with carbon dioxide in supercritical conditions, said conditions comprising temperature in the range between room temperature and 100° C., preferably between 30 and 70° C., and pressure in the range between 60 and 800 bar, preferably between 70 and 150 bar.

19. The process according to claim 13, wherein said treatment of said semicrystalline sample by a volatile guest of said polystyrene, said copolymers, or both comprises a treatment with acetone, acetonitrile, or both.

20. A polymeric material obtainable according to claim 13.

21. A polymeric material obtainable according to claim 14.

22. A polymeric material obtainable according to claim 15.

23. The polymeric material of claim 22, obtainable as a film with thickness lower than 100 μm, preferably lower than 1 μm.

24. A process for the production of materials for detection, transfer, amplification and memory of chirality of optically active compounds comprising the use of a polymeric material of claim 20.

25. A process for the production of materials for detection, transfer, amplification and memory of chirality of optically active compounds comprising the use of a polymeric material of claim 21.

26. A process for the production of materials for detection, transfer, amplification and memory of chirality of optically active compounds comprising the use of a polymeric material of claim 22.

27. A sensor for detection, transfer, amplification and memory of chirality of optically active compounds, containing a polymeric material of claim 22 as a sensing element.

28. A sensor for detection, transfer, amplification and memory of chirality of optically active compounds, containing a polymeric material of claim 23 as a sensing element.

29. A device for storage of data based on a polymeric material of claim 22.

30. A device for storage of data based on a polymeric material of claim 23.
